(19) United States
(12) Patent Application Publication
(10) Pub. No.: US 2007/0241659 A1
(43) Pub. Date: Oct. 18, 2007

(54) Image display device

(75) Inventor: Hiroshi Ito, Chiba (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/783,944

(22) Filed: Apr. 13, 2007

(30) Foreign Application Priority Data
Apr. 17, 2006 (JP) 2006-112953

(51) Int. Cl. H01J 63/04; H01J 1/62

(52) U.S. Cl. 313/496

(57) ABSTRACT

A plurality of spacers are so disposed as to satisfy the equations of

Qx=(W+Gx+5)/(L+Gx)

Gy=−1.5Gx+52.5

Qy=H/Gy

where a length needed for each of the spacers is L, a lateral length of the effective display area of the display panel is W, a vertical length of the effective display area of the display panel is H, the number of the spacers disposed in the lateral direction is Qx, the number of the spacers disposed in the vertical direction is Qy, a placement interval between any two of the spacers in the lateral direction is Gx, and a placement interval between any two of the spacers in the vertical direction is Gy. By optimizing the configuration of a display panel based on the screen size, i.e., the length, the placement interval, and the number of the spacers, the display panel is increased in mechanical strength and display quality so that the resulting image display device becomes able to offer images with good quality and brightness.

### BACKGROUND OF THE INVENTION

1. Field of the Invention

The present invention relates to a flat image display device utilizing electron emission into a vacuum space formed between front and rear substrates, more specifically, to an image display device equipped with a plurality of space keeping members between the front and rear substrates and, more in detail, to the placement configuration of the space keeping members.

2. Description of the Related Art

A color cathode-ray tube has been widely perceived as a display device excellent in brightness and definition. With the improved image quality achieved by the recent information processors and television broadcast, however, a demand is growing for a flat image display device (also referred to as flat panel display (FPD)) that is light in weight and occupies less space with the characteristics of high brightness and definition.

To meet such a demand, as typical examples, a liquid crystal display device and a plasma display device have been in practical use. For more brightness, the study is under way to make practical use of various types of flat image display device as a self-light-emitting display device utilizing electron emission from an electron source into a vacuum space, e.g., electron emission image display device, field emission image display device, and an organic EL (electroluminescent) display characterized in low power consumption, and others.

In such a flat image display device varying in type, a self-light-emitting type is known for an electron source being in a matrix shape. As an example, known is the above-described electron emission image display device (also referred to as electron emission display) utilizing a cold cathode being small in size and possible for packaging.

In a flat self-light-emitting image display device, i.e., FPD, a cold cathode is a thin film electron source of spindt type, surface conductive type, carbon nanotube type, MIM (Metal-Insulator-Metal) type with a metal-insulator-metal lamination, MIS (Metal-Insulator-Semiconductor) type with a metal-insulator-semiconductor lamination, a type with a metal-insulator-semiconductor-metal lamination, or others.

An electron source of MIM type is known as described in Patent Document 1 (JP-A-7-65710) and Patent Document 2 (JP-A-10-153979). A metal-insulator-semiconductor-type electron source is known as being of MOS (Metal Oxide Semiconductor) type, a metal-insulator-semiconductor-metal-type electron source is known as being of HEED (High-Efficiency Electron Emission Device) type, EL (ElectroLuminescent) type, porous silicon type, and others.

The self-light-emitting flat image display device, i.e., FPD, is known as a display panel configured by front and rear substrates and a sealing frame. In the display panel, the rear substrate is disposed to oppose the front substrate, and an internal space between the substrates is sealed by the sealing frame to derive any predetermined degree of vacuum. Herein, the rear substrate is provided with such an electron source as described above. The front substrate is provided with a fluorescent layer, and an anode for use to generate an acceleration voltage to collide electrons coming from the electron source to the fluorescent layer. Such a display panel is operated together with a drive circuit.

In an image display device with an electron source of MIM type, the rear substrate includes a substrate made of an insulator material, on which a plurality of scanning signal electrodes are formed. The scanning signal electrodes are each extended in a first direction, and are disposed in line in a second direction orthogonal thereto so that a scanning signal is sequentially applied in the second direction. This insulator substrate is also formed thereon with a plurality of video signal electrodes that are each extended in the second direction, and are disposed in line along the first direction to intersect the scanning signal electrodes. The electron source is disposed at an intersection portion between any of the scanning signal electrodes and any of the video signal electrodes. These wiring patterns are connected with the electron source by a feed electrode so that the electron source is provided with a current supply.

An electron source is paired with a corresponding fluorescent layer so that a unit pixel is configured. Three unit pixels of red (R), green (G), and blue (B) generally configure a pixel, i.e., color pixel. If with a color pixel, unit pixels of various colors are each referred to as subpixel.

In the flat image display device of the above configuration, a plurality of space keeping members (hereinafter, referred to as spacers) are often fixedly disposed in a space enclosed by front and rear substrates and a support body. The spacers work with the support body to keep the space between the substrates to a predetermined value. These spacers are each made of an insulator material such as glass and ceramics, and shaped like a plate. The spacers are often disposed for a group of pixels at positions not to hinder the pixel operation.

For a flat image display device of such a type, Patent Document 3 (JP-A-7-302560) describes an image display device in which a plurality of spacers are intermittently disposed in the longitudinal direction. Patent Document 4 (JP-A-2002-8568) describes another type of flat image display device in which a spacer is positioned and fixed on a rear plate.

In the previous technologies, an FPD is of the configuration including two substrates, a frame body, and a plurality of spacers. The frame body serves to keep a space between the substrates, and the spacers are disposed in a display area enclosed by the frame body. Such an FPD is required to keep high the degree of vacuum inside of the display panel, and there thus need to dispose a plurality of spacers between a space between the substrates, i.e., about 3 mm, to be resistant to vacuum pressure of a predetermined level. In the current FPD, about three rows of a spacer are disposed in the direction along the longer side of the display panel, and in the direction along the shorter side of the display panel, about six to thirteen rows of a spacer are disposed in parallel and perpendicular. The spacers each have the length of about 100 mm to 110 mm, and are fixedly disposed at intervals of about 30 mm both in the horizontal and vertical directions.

The problem with such an FPD is that, because the space between the substrates is set to minimum, i.e., about 3 mm, an adhesive member for use to fix the spacers often does not serve enough for gas release. This is one cause of a difficulty in keeping high the degree of vacuum, thereby preventing the increase of display life.

Another problem with such an FPD is that the interior of the display panel is not sufficiently subjected to gas release when sealed under a reduced pressure by heating in a sealing process, or at the time of vacuum exhaustion in an exhaustion process. Such not-sufficient gas release resultantly causes gas contamination, thereby degrading the electron emission properties of an electron emission source. Especially the gas between the spacers is hard to release.

### SUMMARY OF THE INVENTION

In consideration thereof, the present invention is proposed to solve the above problems, and an object thereof is to provide an image display device that can offer images with good quality and brightness with the increased mechanical strength and display quality of a display panel by optimizing the configuration of the display panel based on the screen size, i.e., the length, the placement interval, and the number of the spacers.

In order to achieve such an object, an aspect of the invention is directed to an image display device configured by a display panel that includes: a front substrate including, on an inner surface, a fluorescent layer and an anode electrode; a rear substrate including an electron source on an inner surface, and being disposed to oppose the front substrate with a predetermined space therefrom; a frame body being placed around a display area between the front and rear substrates, and keeping the predetermined space; and a plurality of space keeping members disposed in the display area between the front and rear substrates. In the display panel, the frame body, and the front and rear substrates are sealed airtight each via a sealing member, and a plurality of the space keeping members are disposed so that equations of

Qx=(W+Gx+5)/(L+Gx)

Gy=−1.5Gx+52.5

Qy=H/Gy

are satisfied where a length needed for each of the space keeping members is L, a horizontal length of an effective display area of the display panel is W, a longitudinal length of the effective display area of the display panel is H, the number of the space keeping members disposed in the horizontal direction is Qx, the number of the space keeping members disposed in the vertical direction is Qy, a placement interval between any two of the space keeping members (hereinafter, referred to as spacer interval) in the horizontal direction is Gx, and a spacer interval in the vertical direction is Gy.

In the aspect of the invention, the configuration of the display panel is optimized based on the screen size, i.e., the length, the placement interval, and the number of the spacers. Such configuration optimization favorably leads to the satisfactorily excellent effect, e.g., the display panel is increased in mechanical strength and display quality, and the resulting image display is of good quality and brightness.

Also in the aspect of the invention, an internal gas smoothly flows between a plurality of space keeping members in the horizontal and longitudinal directions. This accordingly works well for the residual gas inside of the display panel so that the gas contamination is reduced in the electron source. The resulting image display thus shows excellent electron emission properties, and can be of high in image quality and brightness. This configuration leads to a satisfactorily excellent effect of achieving an image display device with long life, good quality, and high reliability.

Also in the aspect of the invention, the space keeping members are overlaid on the scanning signal electrodes, and are disposed along the same direction as the scanning signal electrodes. This configuration leads to a satisfactorily excellent effect of protecting the electrode components, e.g., electron source and image signal electrode, from any damage.

The foregoing and following descriptions are in all aspects illustrative and not restrictive to the configuration of the invention. It is understood that numerous other modifications and variations can be devised without departing from the scope of the invention:

### BRIEF DESCRIPTION OF THE DRAWINGS

FIG. 1 is a plan view of an image display device in a first embodiment of the invention, viewed from the side of a front substrate;

FIG. 2 is a side view of the image display device of FIG. 1, viewed from an I direction of FIG. 1;

FIG. 3 is a schematic plan view of a rear substrate with no front substrate of FIG. 1;

FIG. 4 is an overall perspective view showing the entire configuration of the image display device of FIG. 1;

FIG. 5 is a schematic enlarged cross sectional view of the rear substrate cut along a line II-II of FIG. 3, and the corresponding front substrate;

FIG. 6 is a schematic enlarged cross sectional view of the rear and front substrates cut along a line III-III of FIG. 3;

FIG. 7 is an overall plan view of spacers of FIG. 1, showing their exemplary placement;

FIG. 8 is a diagram showing the relationship between a lateral interval between the spacers and a buckling load limit value;

FIG. 9 is a diagram showing the relationship between the lateral interval between the spacers and a vertical interval therebetween;

FIG. 10 is a plan view of a main part of the image display device of the invention, showing the configuration of the rear substrate;

FIG. 11 is a plan view of a main part of the image display device of the invention, showing the configuration of the front substrate; and

FIG. 12 is an enlarged cross sectional view of a main part of the image display device of the invention, showing the configuration of a fluorescent surface formed to the front substrate.

### DETAILED DESCRIPTION OF THE INVENTION

In the below, a specific embodiment of the invention is described in detail by referring to the accompanying drawings.

### First Embodiment

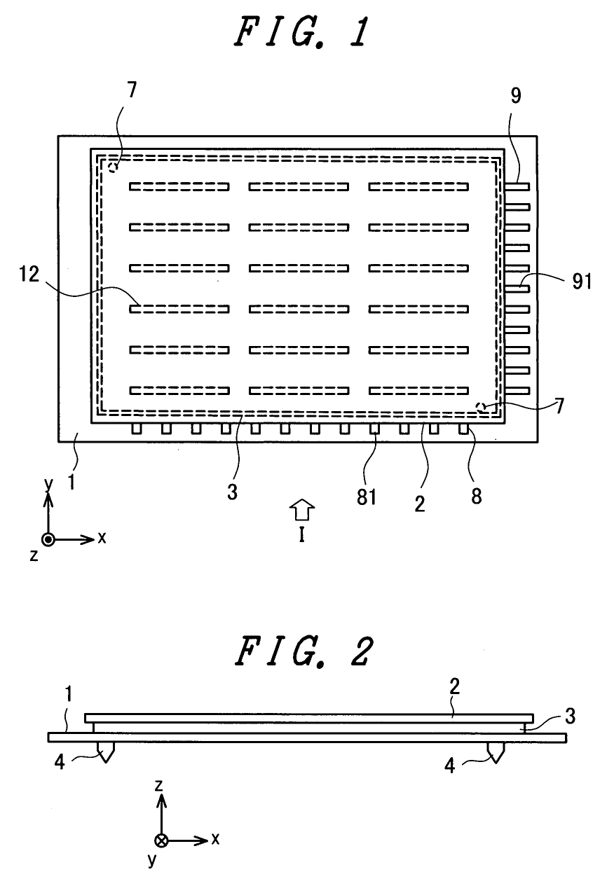

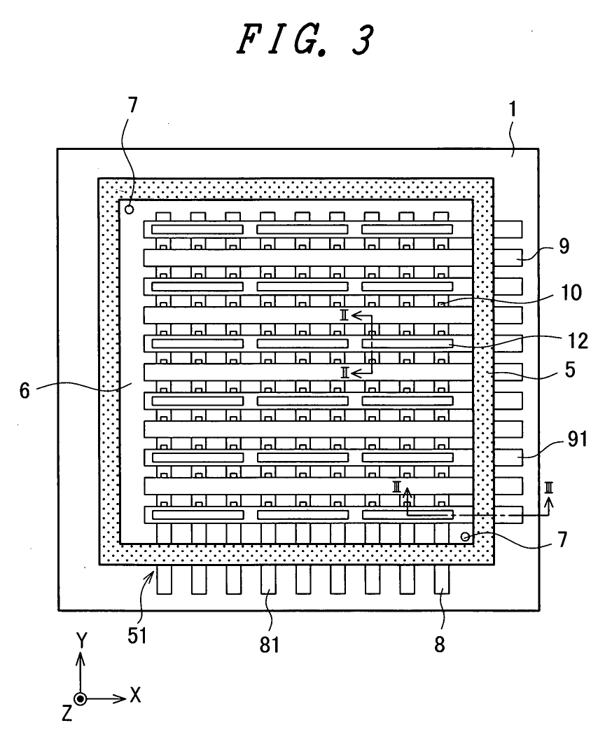

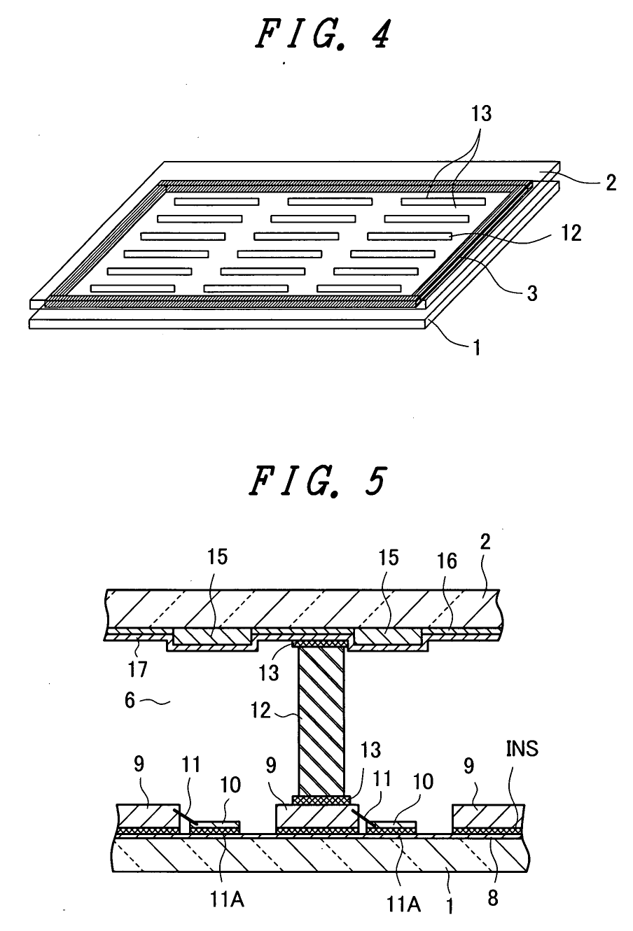

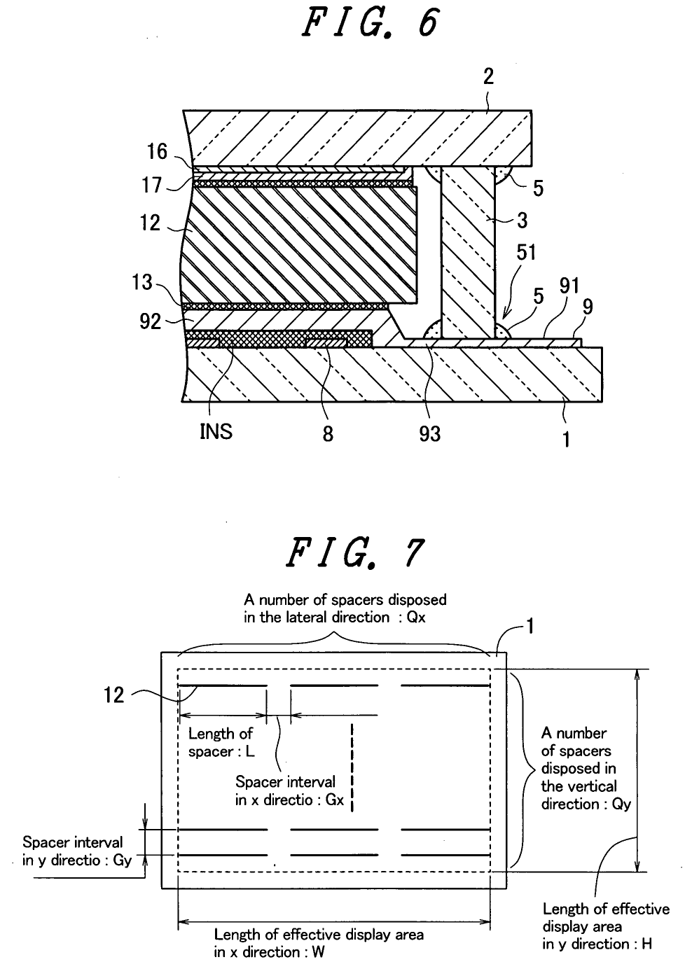

FIGS. 1 to 6 are each a diagram for illustrating an exemplary image display device of the invention. FIG. 1 is a plan view of an image display device, viewed from the side of a front substrate. FIG. 2 is a side view of the image display device of FIG. 1, viewed from an I direction. FIG. 3 is a schematic plan view of a rear substrate with no front substrate of FIG. 1. FIG. 4 is an overall perspective view showing the entire configuration of the image display device. FIG. 5 is a schematic enlarged cross sectional view of the rear substrate cut along a line II-II of FIG. 3, and the corresponding front substrate. FIG. 6 is a schematic enlarged cross sectional view of the rear and front substrates cut along a line III-III of FIG. 3.

In FIGS. 1 to 6, reference numerals 1 and 2 denote a rear substrate and a front substrate, respectively. The rear and front substrates 1 and 2 are each a glass plate with the thickness of about a few mm, e.g., about 3 mm. A reference numeral 3 denotes a frame body (frame) with the thickness of about a few mm, e.g., about 3 mm. The frame body 3 is a glass plate, a sintered body of frit glass, or others. A reference numeral 4 denotes an exhaust pipe, which is fixedly disposed on the rear side of the rear substrate 1, i.e., one at a corner portion and another at a diagonally-opposite corner. The frame body 3 is placed around the outer edge portion between the rear and front substrates 1 and 2, and seals airtight the rear and front substrates 1 and 2 via a sealing member 5 made of a frit glass so that a display panel is configured.

The space enclosed by such components, i.e., the frame body 3, the rear and front substrates 1 and 2, and the sealing member 5, is exhausted via one of the exhaust pipes 4. The space configures a display area 6 with the degree of vacuum of 10⁻³ to 10⁻⁵ Pa, for example. As described above, the pair of exhaust pipes 4 formed at the diagonally-opposite corners of the rear substrate 1 are attached to the rear surface of the rear substrate 1, and go through the rear substrate 1 to be both linked to an exhaust hole 7 punched therein. After the internal space is through with gas exhaustion, the exhaust pipes 4 are chipped off and sealed so that a display panel is formed.

A reference numeral 8 denotes a video signal electrode, which is extended toward inside of the rear substrate 1, i.e., in a Y direction, and is plurally disposed in line in an X direction. These video signal electrodes 8 are each provided with a video signal lead terminal 81 at one end, whose tip end portion is extended up to the end portion of the rear substrate 1 after going through, airtightly, an airtightly-sealed area 51 between the frame body 3 and the rear substrate 1.

A reference numeral 9 denotes a scanning signal electrode, which is located upper the video signal electrodes 8. The scanning signal electrode 9 is extended in the X direction to interest the video signal electrodes 8, and is plurally disposed in line in the Y direction. These scanning signal electrodes 9 are each provided with a scanning signal electrode lead terminal 91 at one end, whose tip end portion is extended up to the end portion of the rear substrate 1 after going through, airtightly, the airtightly-sealed area 51 between the frame body 3 and the rear substrate 1.

In the scanning signal electrode 9, an internal electrode portion 92 located in a vacuum area 6 is formed thicker than a sealing electrode portion 93 located at the portion where the scanning signal electrode lead terminal 91 goes through, airtightly, the sealed area 51. Such a thickness difference reduces voltage reduction in the internal electrode portion 92 so that stress generation is suppressed in the sealed area 51.

A reference numeral 10 denotes an electron source, which is disposed at an intersection portion between the scanning signal electrode 9 and the video signal electrode 8. This electron source 10 is connected to the components, i.e., the scanning signal electrodes 9 and the video signal electrodes 8 via connection electrodes 11 and 11A. Among the video signal electrodes 8, the electron source 10, and the scanning signal electrodes 9, an interlayer insulator film FTR is disposed.

In this example, the video signal electrode 8 is an Al/Nd (aluminum/neodymium) film, and the scanning signal electrode 9 is an Ir/Pt/Au (iridium/platinum/gold) film, for example. Although the electrode lead terminals 81 and 91 are disposed only at one end of the corresponding electrode, these terminals may surely be disposed at both ends thereof.

A reference numeral 12 denotes a spacer being a space keeping member for use to keep the space between the rear and front substrates 1 and 2. The spacer 12 is made of glass or ceramics, for example, and is shaped like a rectangular thin plate. The dimension of the spacer 12 is set based on the dimension of the substrates, the height of the frame body 3, the material of the substrates, the placement interval between the spacers, the material of the spacers, and others. The spacer 12 generally has the height substantially the same as the above-described frame body 3, i.e., about 3 mm, and the thickness of about 0.1 mm to 0.2 mm, and these values are considered practical. Note that this spacer 12 has a resistance value of about 10⁸ to 10⁹ Ω·cm.

As to the spacer 12, the upper and lower end surfaces are adhered and fixed to the rear and front substrates 1 and 2 by an adhesive member 13. These spacers 12 are often disposed for a group of pixels at positions not to hinder the pixel operation.

The determination factor about how many spacers 12 are to be disposed where is as below. That is, the spacers 12 are to be under the atmospheric pressure substantially evenly, are to be scattered not to bend and damage the substrate, and are not to suffer themselves from buckling. The spacers 12 are fixedly attached, at upper and lower end surfaces, to the rear and front substrates 1 and 2 via the adhesive member 13. With such a configuration, the spacers 12 and the frame body 3 keep the space between the rear and front substrates 1 and 2 to a predetermined value.

The interval between the spacers 12 (hereinafter, referred to as spacer interval) in the vertical direction and that in the lateral direction are each a factor to define how many spacers are to be disposed in the horizontal direction, i.e., lateral direction, of the screen of the display panel, and in the longitudinal direction, i.e., vertical direction, thereof.

That is, as shown in the overall plan view of FIG. 7, the spacers 12 are so disposed as to satisfy the following equations of 1, 2, and 3, where any needed length of each of the spacers 12 is L, the lateral length of the effective display area of the display panel is W, the vertical length of the effective display area of the display panel is H, the number of the spacers 12 disposed in the lateral direction is Qx, the number of the spacers 12 disposed in the vertical direction is Qy, the spacer interval in the lateral direction is Gx, and the spacer interval in the vertical direction is Gy.

### Equation 1

Qx=(W+Gx+5)/(L+Gx) 1

### Equation 2

Gy=−1.5Gx+52.5 2

### Equation 3

Qy=H/Gy 3

Described next is an exemplary 32-inch display panel to which the invention is applied. Assuming that the lateral length W of the effective display area of a display panel is about 709 mm, the spacer interval Gx in the lateral direction is about 9.5 mm, and the length L of a spacer is about 110 mm, the number Qx of the spacers disposed in the line direction is 6, and the spacer interval in the row direction Gy is about 38.25 mm.

If with H=about 399 mm for the vertical length of the effective display area of the display panel, the number Qy of the spacers disposed in the vertical direction is 10. If with Gx=0 for the spacer interval in the lateral direction of the display panel, the interval Gy between the spacers in the vertical direction is about 52.5 mm from the equation 2. Analytically, the interval Gy of about 40 mm is the buckling load limit, and thus the possible maximum number of the spacers is 10 in the vertical direction of the display panel, i.e., Qy=10.

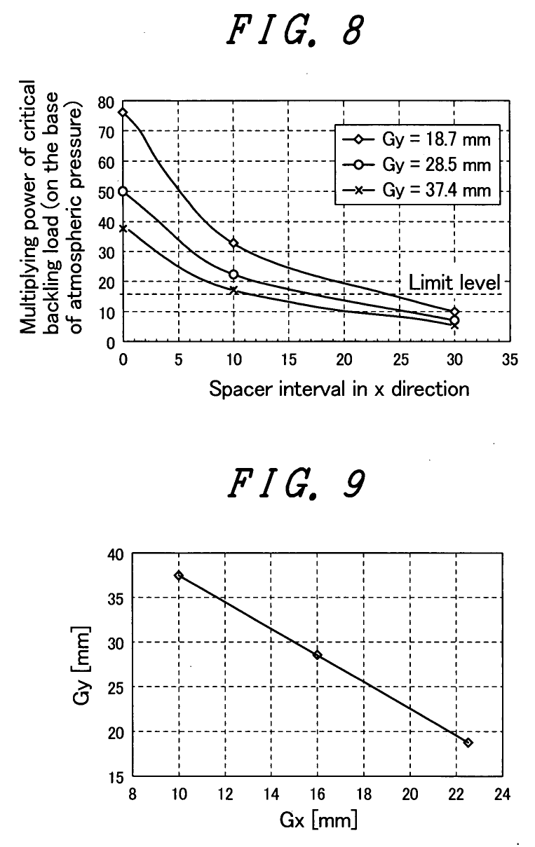

FIG. 8 is a diagram showing the relationship between the spacer interval Gx in the lateral direction and a buckling load limit value for every spacer interval Gy in the vertical direction. FIG. 8 tells the relationship between the spacer intervals Gx and Gy, and FIG. 9 shows the resulting relationship. The relational expression of FIG. 9 is the equation 2 described above, and if with Gx=10 mm for the spacer interval in the lateral direction, the spacer interval Gy in the vertical direction required in view of the buckling load limit for strength is about 37.5 mm.

This tells the number of the spacers in the lateral direction Qx and the number of the spacers in the vertical direction Qy are represented by the equations 1 and 3, respectively. The equations 2 and 3 derive the following equation 4.

### Equation 4

Qy=H/(−1.5Gx+52.5) 4

These equations 1 to 4 are applicable not only to such an application example as above but also to display panels of 17-inch, 32-inch, or larger.

The adhesive member 13 is configured by a mixed structure of a low-melting-point frit glass being a main component, and a conductive component having the particle diameter of a few to a few tens of μm, e.g., about 3 to 10 μm. The low-melting-point frit glass is insulative, and is included about 30 wt % or more but 80 wt % or less. The conductive component is conductive, and is exemplified by silver particles. The low-melting-point frit glass is made up of, mainly, SᵢO₂ (silica), B₂O₃ (boron oxide), and PbO (lead oxide). As to such an adhesive 13, although varying with the chemical makeup, the thickness is set to a tens μm or more in view of secure attachment, desirably about 20 to 40 μm.

On an inner surface of the front substrate 2, fluorescent films 15 for red, green, and blue are partitioned by a BM (black matrix) film 16 for use for light shielding, and a metal back film, i.e., anode electrode, 17 being a metal thin film is so disposed as to cover the fluorescent films 15 so that a fluorescent surface is formed.

The fluorescent element of red is exemplified by Y₂O₂S: Eu (P22-R), the fluorescent element of green is exemplified by ZnS: Cu, Al (P22-G), and the fluorescent element of blue is exemplified by ZnS: Ag, Cl (P22-B). With the fluorescent surface configured as such, electrons coming from the electron source 10 are accelerated, and made to bump to any of the fluorescent films 15 configuring a corresponding pixel. This makes the fluorescent film 15 emit light of predetermined color, and the color is mixed to the color emitted from any other fluorescent films 15 of different pixels so that a color pixel of a predetermined color is configured. Note that the anode electrode 17 is assumed as being a surface electrode. This is not restrictive, and alternatively, the anode electrode 17 may be a stripe electrode that intersects the scanning signal electrodes 9, and is partitioned on a pixel row basis.

With the configuration of the first embodiment, assumed is that the spacer 12 each have the length L of about 110 mm in a 32-inch display panel in which the effective display area W is about 709 mm in the lateral direction, and the effective display area H is about 399 mm in the vertical direction. In this case, the display panel is disposed upright through setting of Qx=6 for the number of spacers 12 in the lateral direction, Gx=about 9.5 mm for the spacer interval in the lateral direction, Qy=10 for the number of spacers in the vertical direction, and Gy=about 38.25 mm for the spacer interval in the vertical direction. With the display panel stood upright as such, the rear and front substrates 1 and 2 are attached and fixed using the adhesive member 13.

In such a configuration, the air coming from one of the exhaust holes 7 formed at one corner portion of the display panel smoothly flows in the display panel along the placement direction of the spacers 12. When the air flows out under a reduced pressure by vacuuming or sucking from the other opposing exhaust hole 7, the internal gas flows evenly over the inner surface of the display panel. This favorably works well for the residual gas inside of the display panel so that the gas contamination by the internal gas is reduced in the electron source 10, thereby preventing deterioration of the electron emission properties.

In such a configuration, i.e., the spacers 12 are scattered with the settings, to the above-described values, of the number Qx of the spacers and the spacer interval Gx disposed in the lateral direction of the display panel, the number Qy of the spacers and the spacer interval Gy disposed in the vertical direction of the display panel, and the upper and lower end surfaces of each of the spacers 12 are attached to the rear and front surfaces 1 and 2 via the adhesive member 13, the spacers 12 are to be under the atmospheric pressure substantially evenly. The substrates are thus not easily bent and damaged, and hardly suffer from buckling. The mechanical strength is increased so that the space between the rear and front substrates 1 and 2 is firmly kept to a predetermined value with the frame body 3.

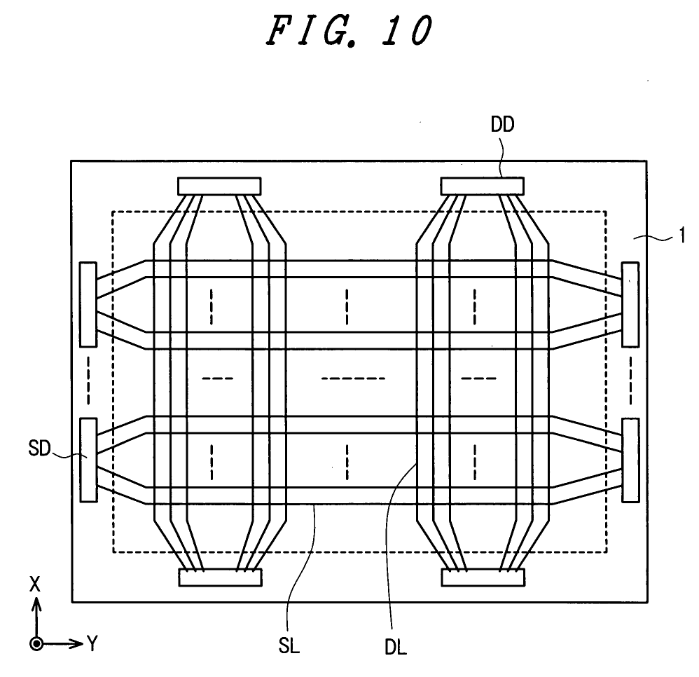

FIG. 10 is a plan view of a main part of the image display device of the invention, showing the rear substrate viewed from inside. In FIG. 10, the main surface, i.e., front surface, of the rear substrate 1 preferably made of glass or ceramics, is provided thereon with a plurality of data lines DL and a plurality of scanning lines SL. The data lines DL are extended in a first direction, i.e., y direction, and are disposed in line in a second direction, i.e., x direction intersecting the first direction. The data limes DL are also referred to as cathode lines. The scanning lines SL are extended in the second direction, i.e., x direction, and are disposed in line in the first direction, i.e., y direction, intersecting the second direction. The data lines DL and the scanning lines SL are disposed in matrix as such, and at the intersection portions therebetween or in the vicinity thereof, an electron emission element is each formed.

The scanning lines SL are each connected, at one end, to a scanning driver SD, and the data lines DL are each connected, at one end, to a data driver DD. The front substrate is disposed opposing the rear substrate along the broken lines in the drawing. The front and rear substrates 2 and 1 are attached together along the outer rim of the opposing area, and are sealed with the internal gas exhausted. The spacers described above are disposed on the scanning lines SL.

FIG. 11 is a plan view of a main part of the image display device of the invention, showing the front substrate viewed from inside. In FIG. 11, the internal surface of the front substrate 2 made of a translucent glass material is formed with, along the length direction of the data lines DL of FIG. 10, a fluorescent surface PH including a red fluorescent layer PHR, a green fluorescent layer PHG, and a blue fluorescent layer PHB. The fluorescent surface PH is formed with a black matrix film BM, which serves to partition the red fluorescent layer PHR, the green fluorescent layer PHG, and the blue fluorescent layer PHB.

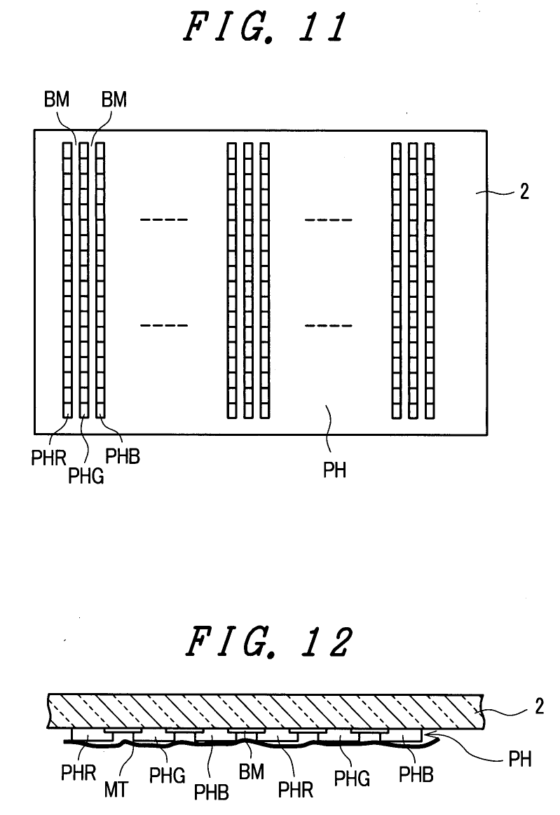

FIG. 12 is an enlarged cross sectional view of the fluorescent surface PH formed to the inner surface of the front substrate 2. In FIG. 12, the fluorescent surface PH, i.e., the red fluorescent layer PHR, the green fluorescent layer PHG, and the blue fluorescent layer PHB, is so formed as to partially cover the black matrix film BM. The fluorescent surface PH is formed thereon with a metal-back film MT for use to make, effectively reflect, light emitted from the layers, i.e., the red fluorescent layer PHR, the green fluorescent layer PHG, and the blue fluorescent layer PHB. The metal-back film MT is provided with an anode voltage so that the film MT serves as an anode electrode. The spacers described above are disposed on the black matrix film BM.

In the embodiment described above, described is the case with the image display device in which a front substrate includes, on an inner surface, fluorescent films and a black matrix film, and the fluorescent films and the black matrix film are formed with a metal-back film, i.e., anode electrode on the back surface thereof. The present invention is surely not restrictive thereto.

1. An image display device configured by a display panel, comprising:
a front substrate including, on an inner surface, a fluorescent layer and an anode electrode;
a rear substrate including an electron source on an inner surface, and being disposed to oppose the front substrate with a predetermined space therefrom;
a frame body being placed around a display area between the front and rear substrates, and keeping the predetermined space; and
a plurality of space keeping members being disposed in the display area between the front and rear substrates, wherein
the frame body, and the front and rear substrates are sealed airtight each via a sealing member, and
equations of
Qx=(W+Gx+5)/(L+Gx)
Gy=−1.5Gx+52.5
Qy=H/Gy
are satisfied where a length of each of the space keeping members is L, a horizontal length of an effective display area of the display panel is W, a longitudinal length of the effective display area of the display panel is H; the number of the space keeping members disposed in a horizontal direction is Qx, the number of the space keeping members disposed in a longitudinal direction is Qy, a placement interval between any two of the space keeping members (hereinafter, referred to as spacer interval) in the horizontal direction is Gx, and a spacer interval in the vertical direction is Gy.

2. The image display device according to claim 1, wherein
the spacer interval in the longitudinal direction Gy is 40 mm or smaller.

3. The image display device according to claim 1, wherein
a thickness of each of the space keeping members falls in a range from 0.1 mm to 0.2 mm.

4. The image display device according to claim 1, wherein
the space keeping members are each made of ceramics or glass.

5. The image display device according to claim 1, wherein
the space keeping members each have a resistance value of 10⁸ to 10⁹ Ω·cm.

6. The image display device according to claim 1, wherein
the rear substrate comprises:
a plurality of scanning signal electrodes that are extended in one direction and disposed in line in an other direction orthogonal to the one direction, and are each sequentially provided with a scanning signal in the other direction;
a plurality of video signal electrodes that are extended in the other direction, and are disposed in line in the one direction to intersect a wiring pattern of the scanning signals; and
an electron source provided at an intersection portion between any of the scanning signal electrodes and any of the video signal electrodes; and
a feed electrode for establishing a connection among the electron source, the scanning signal electrodes, and the video signal electrodes.

7. The image display device according to claim 6, wherein
the space keeping members are overlaid on the scanning signal electrodes, and are disposed along the same direction as the scanning signal electrodes.

8. The image display device according to claim 1, wherein
at least two exhaust holes are provided, with a space therebetween, to go through the display panel in which the front and rear substrates and the frame body are sealed airtight.

9. The image display device according to claim 8, wherein
the exhaust holes are each disposed at a corner portion of the display panel.

10. The image display device according to claim 2, wherein
a thickness of each of the space keeping members falls in a range from 0.1 mm to 0.2 mm.

11. The image display device according to claim 2, wherein
the space keeping members are each made of ceramics or glass.

12. The image display device according to claim 2, wherein
the space keeping members each have a resistance value of 10⁸ to 10⁹ Ω·cm.

13. The image display device according to claim 2, wherein
the rear substrate comprises:
a plurality of scanning signal electrodes that are extended in one direction and disposed in line in an other direction orthogonal to the one direction, and are each sequentially provided with a scanning signal in the other direction;
a plurality of video signal electrodes that are extended in the other direction, and are disposed in line in the one direction to intersect a wiring pattern of the scanning signals; and
an electron source provided at an intersection portion between any of the scanning signal electrodes and any of the video signal electrodes; and
a feed electrode for establishing a connection among the electron source, the scanning signal electrodes, and the video signal electrodes.

14. The image display device according to claim 3, wherein
the rear substrate comprises:
a plurality of scanning signal electrodes that are extended in one direction and disposed in line in an other direction orthogonal to the one direction, and are each sequentially provided with a scanning signal in the other direction;
a plurality of video signal electrodes that are extended in the other direction, and are disposed in line in the one direction to intersect a wiring pattern of the scanning signals; and
an electron source provided at an intersection portion between any of the scanning signal electrodes and any of the video signal electrodes; and
a feed electrode for establishing a connection among the electron source, the scanning signal electrodes, and the video signal electrodes.

15. The image display device according to claim 4, wherein
the rear substrate comprises:
a plurality of scanning signal electrodes that are extended in one direction and disposed in line in an other direction orthogonal to the one direction, and are each sequentially provided with a scanning signal in the other direction;
a plurality of video signal electrodes that are extended in the other direction, and are disposed in line in the one direction to intersect a wiring pattern of the scanning signals; and
an electron source provided at an intersection portion between any of the scanning signal electrodes and any of the video signal electrodes; and
a feed electrode for establishing a connection among the electron source, the scanning signal electrodes, and the video signal electrodes.

16. The image display device according to claim 5, wherein
the rear substrate comprises:
a plurality of scanning signal electrodes that are extended in one direction and disposed in line in an other direction orthogonal to the one direction, and are each sequentially provided with a scanning signal in the other direction;
a plurality of video signal electrodes that are extended in the other direction, and are disposed in line in the one direction to intersect a wiring pattern of the scanning signals; and
an electron source provided at an intersection portion between any of the scanning signal electrodes and any of the video signal electrodes; and
a feed electrode for establishing a connection among the electron source, the scanning signal electrodes, and the video signal electrodes.

17. The image display device according to claim 13, wherein
the space keeping members are overlaid on the scanning signal electrodes, and are disposed along the same direction as the scanning signal electrodes.

18. The image display device according to claim 14, wherein
the space keeping members are overlaid on the scanning signal electrodes, and are disposed along the same direction as the scanning signal electrodes.

19. The image display device according to claim 15, wherein
the space keeping members are overlaid on the scanning signal electrodes, and are disposed along the same direction as the scanning signal electrodes.

20. The image display device according to claim 16, wherein
the space keeping members are overlaid on the scanning signal electrodes, and are disposed along the same direction as the scanning signal electrodes.
